(19) United States
(12) Patent Application Publication
(10) Pub. No.: US 2025/0070656 A1
(43) Pub. Date: Feb. 27, 2025

(54) HYSTERIC CONTROL FOR RESONANT CONVERTERS

(71) Applicant: TEXAS INSTRUMENTS INCORPORATED, Dallas, TX (US)

(72) Inventors: Saad Pervaiz, Tyler, TX (US); Johan Strydom, Saratoga, CA (US); Maida Farooq, Ithaca, NY (US); Branko Majmunovic, Dallas, TX (US)

(21) Appl. No.: 18/453,956

(22) Filed: Aug. 22, 2023

(51) Int. Cl. H02M 3/00; H02M 1/00; H02M 1/38; H02M 3/335

(52) U.S. Cl. CPC H02M 3/01; H02M 1/0009; H02M 1/38; H02M 3/33571

(57) ABSTRACT

An apparatus includes a resonant converter controller having a converter voltage sensing terminal, a reference voltage terminal, a converter current sensing terminal, first and second converter capacitor terminals, and first and second control outputs. The resonant converter controller is configured to: receive a current sensing signal at the converter current sensing terminal; generate a first signal based on the current sensing signal; generate a second signal representing a difference between a first voltage at the converter voltage sensing terminal and a reference voltage at the reference voltage terminal; and generate first and second switching signals at, respectively, the first and second control outputs responsive to the first signal, the second signal, and a capacitor voltage between the first and second converter capacitor terminals to regulate the first voltage based on the reference voltage.

### BACKGROUND

One type of switching power converter is an LLC power converter. The output stage of an LLC power converter includes an output capacitor, such as an electrolytic capacitor. The estimated series resistance (ESR) of the output capacitor may reduce the operating efficiency of the LLC power converter due to the power dissipation in the capacitor's ESR. Larger electrolytic capacitors have smaller values of ESR than smaller electrolytic capacitors. Accordingly, larger sized electrolytic capacitors beneficially improve the LLC power converter's operating efficiency but do so at the expense of their larger size and thus larger size of the power converter.

Using a smaller sized output capacitor can reduce the footprint/size of the power converter. However, a smaller output capacitor causes the power converter to have a larger output impedance. Due to bandwidth limitations of the converter's control loop, a large output impedance may cause a large output voltage undershoot upon a sudden increase in the load current. The large output impedance may also cause a large output voltage overshoot upon a sudden decrease in the load current.

### SUMMARY

In one example, an apparatus includes a resonant converter controller having a converter voltage sensing terminal, a reference voltage terminal, a converter current sensing terminal, first and second converter capacitor terminals, and first and second control outputs. The resonant converter controller is configured to: receive a current sensing signal at the converter current sensing terminal; generate a first signal based on the current sensing signal; generate a second signal representing a difference between a first voltage at the converter voltage sensing terminal and a reference voltage at the reference voltage terminal; and generate first and second switching signals at, respectively, the first and second control outputs responsive to the first signal, the second signal, and a capacitor voltage between the first and second converter capacitor terminals to regulate the first voltage based on the reference voltage.

In another example, a method includes receiving a first voltage from an output of a resonant converter; receiving a second voltage across a capacitor of the resonant converter; receiving a reference voltage; and receiving a current measurement signal from the output of the resonant converter. The method also includes generating a switching signal of the resonant converter responsive to the first voltage, the second voltage, and the current measurement signal to regulate the first voltage based on the reference voltage.

In yet another example, a non-transitory computer readable medium stores instructions that, when executed by processor circuitry, cause the processor circuitry to: receive a first voltage from an output of a resonant converter; receive a second voltage across a capacitor of the resonant converter; receive a reference voltage; receive a current measurement signal from the output of the resonant converter; and generate a switching signal of the resonant converter responsive to the first voltage, the second voltage, and the current measurement signal to regulate the first voltage based on the reference voltage.

### BRIEF DESCRIPTION OF THE DRAWINGS

FIG. 1 is a schematic diagram of a power converter which includes a resonant converter controller having a control signal generation circuit and a feedforward circuit, in an example.

FIG. 2 is a schematic diagram of a portion of the controller illustrating an example of how the feedforward circuit can be coupled to the control signal generation circuit.

FIG. 3 is a graph showing an example of a frequency compensation ramp voltage included as part of the resonant controller, in an example.

FIG. 4 is a schematic diagram of a portion of the resonant converter controller showing another example of how the feedforward circuit can be coupled to the control signal generation circuit.

FIG. 5 is a flow chart illustrating the operation of the resonant converter controller, in an example.

FIG. 6 is a block diagram of an example processing platform including processor circuitry structured to execute the machine-readable instructions and/or the example operations of FIG. 5 to implement the resonant converter controller of FIGS. 1, 2, and 4.

### DETAILED DESCRIPTION

The same reference numbers or other reference designators are used in the drawings to designate the same or similar (either by function and/or structure) features.

The examples described herein pertain to a power converter (e.g., an LLC power converter) which employs a hybrid hysteric controller (HHC) that improves the transient response of the power converter to thereby allow the use of a smaller output capacitor, which can reduce the overall footprint/size of the power converter.

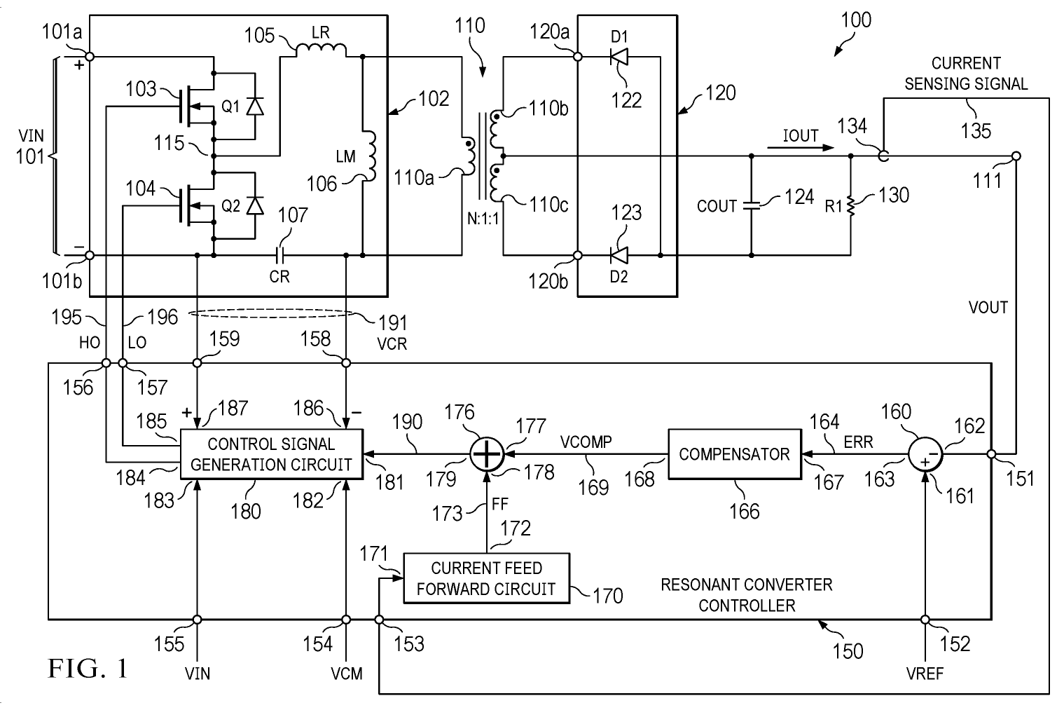

FIG. 1 is a schematic diagram of an example power converter 100 (e.g., a resonant power converter). Power converter 100 includes a resonant inductor 105 (also labelled LR) and a resonant capacitor 107 (also labelled CR). Accordingly, power converter 100 in the example of FIG. 1 is a type of LLC power converter. Power converter 100 has a positive input terminals 101a and a negative input terminal 101b (collectively, input 101), which receive an input voltage VIN, and an output 111, which provides an output voltage VOUT. In addition to inductor LR 105 and resonant capacitor CR 107, power converter 100 includes transistors Q1 103 and Q2 104, a transformer 110, a rectifier 120, an output capacitor (also labelled COUT) 124, a current sense circuit 134, and a resonant converter controller 150. Resistor 130 represents the resistance of a load powered by power converter 100. In this example, transistors Q1 103 and Q2 104 are n-channel field effect transistors (NFETs) and are coupled in series across input 101. The source of transistor Q1 103 is coupled to the drain of transistor Q2 104 at a switching terminal 115. Inductor LR 105 and resonant capacitor CR 107 are coupled in series between switching terminal 115 and input terminal 101b.

Transformer 110 has a primary winding 110a and secondary windings 110b and 110c. Primary winding 110a has a magnetizing inductance (LM) 106. The resonant inductor 105 is coupled between the switching terminal 115 and the primary winding 101b. The resonant capacitor 107 is coupled between the primary winding 101b and negative input terminal 101b. Rectifier 120 has rectifier terminals 120a and 120b. Rectifier terminal 120a is coupled to a terminal of secondary winding 110b, and rectifier terminal 120b is coupled to terminal of secondary winding 110c. Rectifier 120 can include diodes 122 and 123 (also labelled D1 and D2). The cathode of diode D1 122 is coupled to rectifier terminal 120a, and the cathode of D2 diode 123 can be coupled to rectifier terminal 120b. The anodes of diode D2 122 and diode D2 123 are coupled together. Secondary windings 110b and 110c are coupled together and to the output 111. Output capacitor COUT 124 is coupled between the output 111 and the anode of diode D2 123. Current sense circuit 134 is any type of circuit that can produce a current sensing signal 135 (e.g., a voltage) proportional to the output current IOUT from power converter 100. In one example, current sense circuit 134 can include a low resistance resistor (e.g., on the order of milliohms) coupled across a conduction path of output current IOUT, and the voltage across the resistor can be proportional to the output current IOUT. Current sense circuit 134 may also include an amplifier having inputs coupled across the resistor to amplify the voltage of the resistor to produce current sensing signal 135.

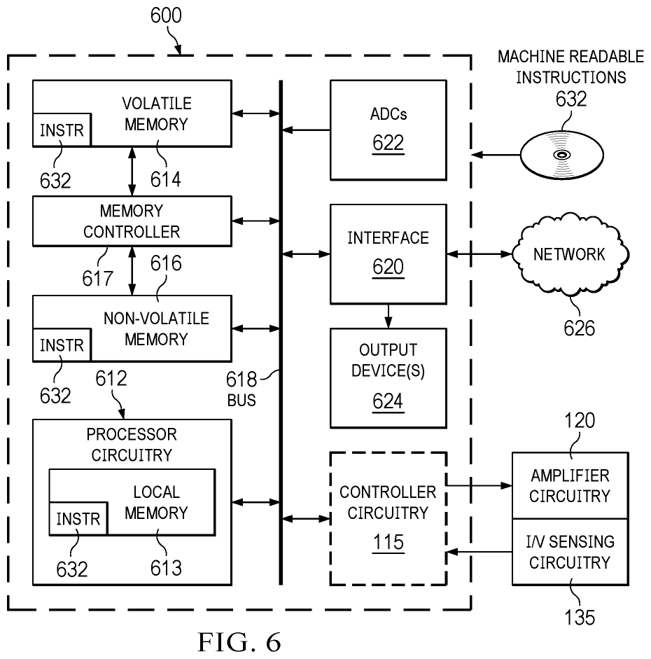

In one example, resonant converter controller 150 can be a hybrid hysteric controller such as that shown in FIG. 1. Various components of resonant converter controller 150 can be implemented in any suitable circuit or component capable of performing processing and/or control, such as a processer, microprocessor, controller, microcontroller, field-programmable gate array (FPGA), or any other combination of analog and/or digital components arranged in an architecture that provides processing and control capabilities. Resonant converter controller 150 can be implemented as a processor executing machine-readable instructions, an example of which is shown in FIG. 6, described below. In an example, resonant converter controller 150 can be implemented in the form of an integrated circuit (IC).

Resonant converter controller 150 includes a converter output voltage sensing terminal 151, a reference voltage terminal 152, a current sensing terminal 153, a common mode voltage sensing terminal 154, a converter input voltage sensing terminal 155, control outputs 156 and 157, and capacitor terminals 158 and 159. Converter output voltage sensing terminal 151 can be coupled to the power converter's output 111. A reference voltage VREF is provided to reference voltage terminal 152. Resonant converter controller 150 can adjust the on/off timing of transistors Q1 and Q2 to maintain output voltage VOUT approximately equal to the reference voltage VREF.

Common mode voltage sensing terminal 154 may receive a common mode voltage VCM. In one example, the common mode voltage VCM can be generated using, for example, a band-gap reference circuit or other suitable circuits. In some examples, the common mode voltage VCM can be generated within resonant converter controller 150.

The converter input voltage sensing terminal 155 is coupled to the input 101 of the power converter and receives the input voltage VIN. Control outputs 156 and 157 are coupled to the respective gates of transistors Q1 and Q2. The control signal generation circuit 180 generates a high command control signal HO 195 for the gate of transistor Q1 and a low command control signal LO 196 for the gate of transistor Q2. Capacitor terminals 158 and 159 are coupled to opposing terminals of resonant capacitor CR 107 and accordingly receive a voltage VCR 191 across the resonant capacitor CR 107.

Resonant converter controller 150 includes a subtractor 160, a compensator 166, a current feedforward circuit 170, a adder 176, and a control signal generation circuit 180. Subtractor 160 has subtractor inputs 161 and 162 and a subtractor output 163. Subtractor input 161 is coupled to the reference voltage terminal 152, and accordingly receives the reference voltage VREF. Subtractor input 162 is coupled to the converter output voltage sensing terminal 151, and accordingly receives output voltage VOUT. Subtractor output 163 is coupled to an input 167 of compensator 166. An output 168 of compensator 166 is coupled to an input 177 of adder 176. Current feedforward circuit 170 has an input 171 and an output 172. The input of current feedforward circuit 170 is coupled to the current sensing terminal 153. The output 172 of current feedforward circuit 170 is coupled to an input 178 of adder 176. The output 179 of adder 176 is coupled to an input 181 of the control signal generation circuit 180. Input 182 of the control signal generation circuit 180 is coupled to the common mode voltage sensing terminal 154 and receives the common mode voltage VCM. Input 183 of the control signal generation circuit 180 is coupled to the converter input voltage sensing terminal 155 and receives the input voltage VIN. Outputs 184 and 185 of the control signal generation circuit 180 are coupled to respective control outputs 156 and 157 and provide respective high and low command control signals HO and LO 195 and 196 to the gates of transistors Q1 and Q2. Inputs 186 and 187 of the control signal generation circuit 180 are coupled to respective capacitor terminals 158 and 159 and receive the capacitor voltage VCR 191.

Subtractor 160 can subtract the output voltage VOUT from the reference voltage VREF to produce an error signal 164 (also labelled ERR). Error signal ERR 164 is provided to the input 167 of compensator 166, and compensator 166 generates a compensation signal (also labelled VCOMP) 169 based on the error signal ERR 164. Current feedforward circuit 170 produces a feedforward signal 173 (also labelled FF) based, at least in part, on the current sensing signal 135. Feedforward signal FF 173 can be provided to input 178 of adder 176. In some examples, current feedforward circuit 170 produces the feedforward signal FF 173 also based on at least one of: a target level for the converter's output voltage VOUT, a target level for the converter's input voltage VIN, the capacitance of resonant capacitor CR 107, or a switching frequency of transistors Q1 and Q2. Adder 176 can add feedforward signal FF 173 to compensation signal VCOMP 169 to produce a threshold signal 190 which is provided to input 181 of the control signal generation circuit 180. The control signal generation circuit 180 produces switching signals (high command control signal HO 195 and low command control signal LO 196) on the control outputs 184 and 185 to turn on and off transistors Q1 and Q2 to control the magnitude of the output voltage VOUT. The control signal generation circuit 180 can produce the switching signals responsive to, for example, the feedforward signal FF 173, the error signal ERR 164, and the capacitor voltage VCR 191.

Absent the current feedforward circuit 170 and adder 176 (that is, assuming the compensation signal VCOMP 169 is provided directly to input 181 of the control signal generation circuit 180), a sudden change in output current IOUT can cause an opposite change in output voltage VOUT. For example, a sudden increase in output current IOUT causes a temporary decrease (undershoot) in output voltage VOUT, while a sudden decrease in output current IOUT causes a temporary increase (overshoot) in output voltage VOUT. Resonant converter controller 150 responds to such decreases or increases in the output voltage VOUT by adjusting the timing of transistors Q1 and Q2 to cause the output voltage VOUT to return to its target level, which is approximately equal to the reference voltage VREF. However, the bandwidth of resonant converter controller 150 (and in particular, compensator 166) is limited, and the resonant converter controller 150 may not be able to reduce the VOUT undershoot/overshoot at a sufficient speed, and the load may experience a large voltage supply undershoot/overshoot as a result. For example, due to sampling delays, computation delays, modulation delays, etc., digital-based (e.g., processor-based) implementations of resonant converter controller 150 may have a lower bandwidth than corresponding analog implementation. Output capacitor COUT 125 could be selected to have a relatively large size to reduce the output impedance of power converter 100 and limit the magnitude of the output voltage undershoot and/or overshoot. However, larger capacitors may be undesirable for many space-constrained applications.

In the example of FIG. 1, current feedforward circuit 170 can improve the bandwidth of the resonant converter controller 150 in responding to the VOUT undershoot/overshoot, which allows a small output capacitor COUT 125 to be used to limit the VOUT undershoot and/or overshoot. Specifically, the current feedforward circuit 170 provides a feedforward signal FF 173, which is based on the output current IOUT, into the control loop for the power converter 100 to counteract the sudden changes in output current IOUT. For example, the current feedforward circuit 170 can increase the magnitude of the feedforward signal FF 173 in response to a sudden increase in output current IOUT to supply additional current to the load, which can counteract, to a certain degree, the undershoot in the output voltage VOUT. Similarly, the current feedforward circuit 170 can decrease the magnitude of the feedforward signal FF 173 in response to a sudden decrease in output current IOUT to reduce the current supplied to the load, which can counteract, to a certain degree, the overshoot in the output voltage VOUT. The feedforward signal FF 173 can bypass compensator 166 in reaching control signal generation circuit 180, which allows control signal generator circuit 180 to receive and respond to an indication of the sudden changes in IOUT faster.

In some examples, the feedforward signal 173 can be generated as a function (e.g., a linear function) of the current sensing signal 135 as K1×(current sensing signal 135)+K2. In one example, current feedforward circuit 170 generates the feedforward signal FF 173 as follows:

$$( Equation 1 )$$

$$FF signal = \frac{( {VOUT}_{ave} \times ( current\_sense {\_signal}_{135} ) + {VIN}_{ave}^{2} \times CR \times {f}_{s} ) )}{2 \times {VIN}_{ave} \times CR \times {f}_{s}}$$

where VOUTₐᵥₑ is the average output voltage, VINₐᵥₑ is the average input voltage, and fₛ is the switching frequency of transistors Q1 and Q2. In one example, resonant converter controller 150 can sense the input voltage and the output voltage, and generate feedforward signal FF 173 based on Equation 1 where VOUTₐᵥₑ is replaced by the sensed output voltage and VINₐᵥₑ is replaced by the sensed input voltage. In other examples, the input voltage may be preset within the controller. The value of the switching frequency may be preset within the resonant converter controller 150 or the switching frequency can be determined by the controller based on the HO and LO control signals it produces. In an example, the current feedforward circuit 170 can be implemented as processor circuitry executing machine instructions (refer to the example of FIG. 6 and the corresponding text) to calculate the feedforward signal 173 based on Equation (1).

Current feedforward circuit 170 can adjust the magnitude of the feedforward signal 173 responsive to a change in the current sensing signal 135 after a first delay. Compensator 166 can adjust the magnitude of the compensation signal 169 (also labelled VCOMP) responsive to a change in the output voltage VOUT after a second delay. The second delay of compensator 166 is longer than the first delay of current feedforward circuit 170, which means that current feedforward circuit 170 can react faster than compensator 166 to adjust threshold signal 190 to the control signal generation circuit 180, and the control signal generation circuit 180 can adjust the timing of transistors Q1 and Q2 to reduce the magnitude of the output voltage VOUT undershoot and/or overshoot.

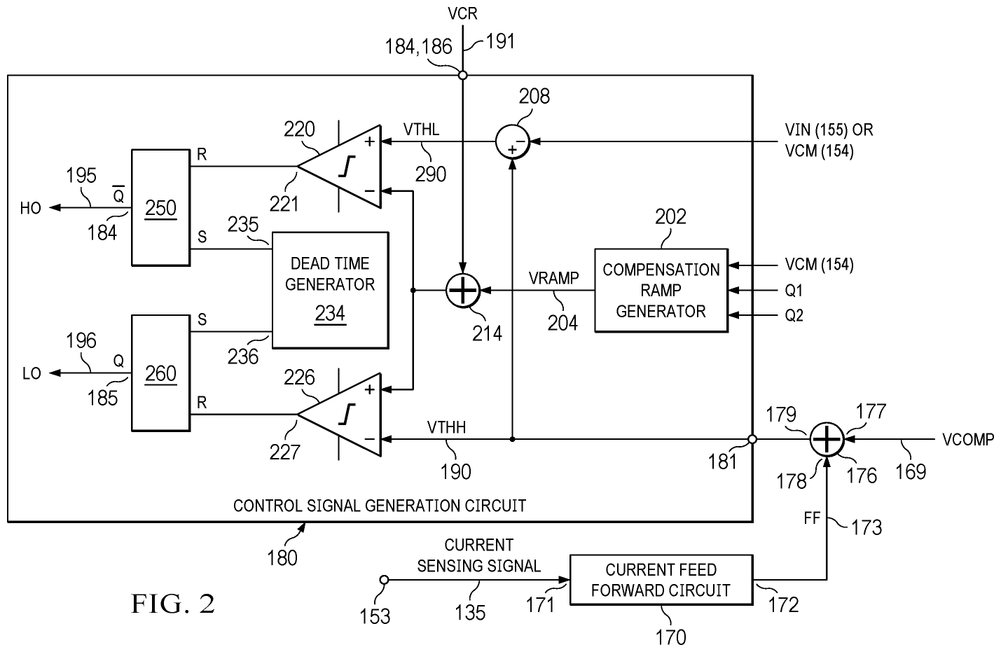

FIG. 2 is a schematic diagram of the control signal generator circuit 180 in an example. In this example, control signal generator circuit 180 can include a compensation ramp generator 202, a subtractor 208, an adder 214, comparators 220 and 226, dead time generator 234, and set(S) reset (R) flip-flops 250 and 260. VIN, from terminal 155, or VCM, from terminal 154 can be provided to the positive (+) input of subtractor 208. Output 179 of adder 176 is coupled to the negative (−) input of subtractor 208, which thus receives the threshold signal 190 (also labelled as VTHH). The output of subtractor 208 provides a threshold signal 290 (also labelled as VTHL) and is coupled to the positive input of comparator 220, and the input 181 of the control signal generation circuit 180 is coupled to the negative input of comparator 226. Accordingly, the positive input of comparator 220 receives threshold signal VTHL 290, and the negative input of comparator 226 receives threshold signal VTHH 190. The capacitor voltage VCR 191 is provided via inputs 186, 187 to one input of adder 214. The compensation ramp generator 202 produces a ramp signal VRAMP 204. The output of the compensation ramp generator 202 is coupled to the other input of adder 214. The output of adder 214 is coupled to the negative input of comparator 220 and to the positive input of comparator 226. Output 221 of comparator 220 is coupled to an R input of SR flip-flop 250. Output 227 of comparator 226 is coupled to an r input of SR flip-flop 250. Outputs 235 and 236 of dead time generator 234 are coupled to the S inputs of SR flip-flops 250 and 260. The output of SR flip-flop 250 is coupled to the control output 184, and the output of SR flip-flop 260 is coupled to the control output 185.

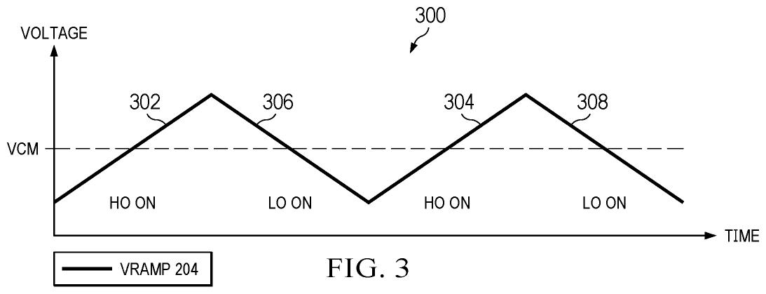

FIG. 3 is a waveform 300 showing an example of the ramp signal VRAMP 204, which is generated by the compensation ramp generator 202. Ramp signal VRAMP 204 is a triangular wave with a constant slope with time and can be synchronized with the high command control signal HO 195 and the low command control signal LO 196. When the high command control signal HO 195 is high, the slope of the ramp signal VRAMP 204 is positive as shown by segments 302 and 304, and transistor Q1 is on (conducting). When the low command control signal LO 196 is high, the slope of the ramp signal VRAMP 204 is negative as shown by segments 306 and 308, and transistor Q2 is on. When both the high command control signal HO and the low command control signal LO are low, the slope of the ramp signal VRAMP 204 is zero, meaning that the ramp signal VRAMP 204 is not changing. The common mode voltage of the ramp signal VRAMP 204 is common mode voltage VCM. The compensation ramp generator 202 receives inputs of the common mode voltage VCM, the high command control signal HO 195, and the low command control signal LO 196 to generate the triangular waveform of the ramp signal VRAMP 204 centered about the common mode voltage VCM.

Comparators 220 and 226 compare the respective threshold signals VTHL and VTHH to the capacitor voltage VCR for generation of the signals to the R inputs of the respective SR flip-flops 250 and 260. The dead time generator 234 generates signals to the S inputs of SR flip-flops 250 and 260 to cause the HO and LO signals to turn on the respective transistors Q1 and Q2. For example, when the dead time generator 234 asserts a signal to a logic high state at the S input of SR flip-flop 250, flip-flop 250 responds by asserting the high command control signal HO 195 to a logic high level thereby turning on transistor Q1. Similarly, when the dead time generator 234 asserts a signal to a logic high state at the S input of SR flip-flop 260, flip-flop 260 responds by asserting the low command control signal LO 196 to a logic high level thereby turning on transistor Q2. Further, when the threshold signal VTTL 290 is greater than the output signal from adder 214, comparator 220 asserts a signal at the R input of SR flip-flop 250, and SR flip-flop 250 responds by forcing the high command control signal HO 195 to a logic low state thereby causing transistor Q1 to turn off. Similarly, when the threshold signal VTTH 190 is lower than the output signal from adder 214, comparator 226 asserts a signal at the R input of SR flip-flop 260, and SR flip-flop 260 responds by forcing the low command control signal LO 196 to a logic low state thereby causing transistor Q2 to turn off.

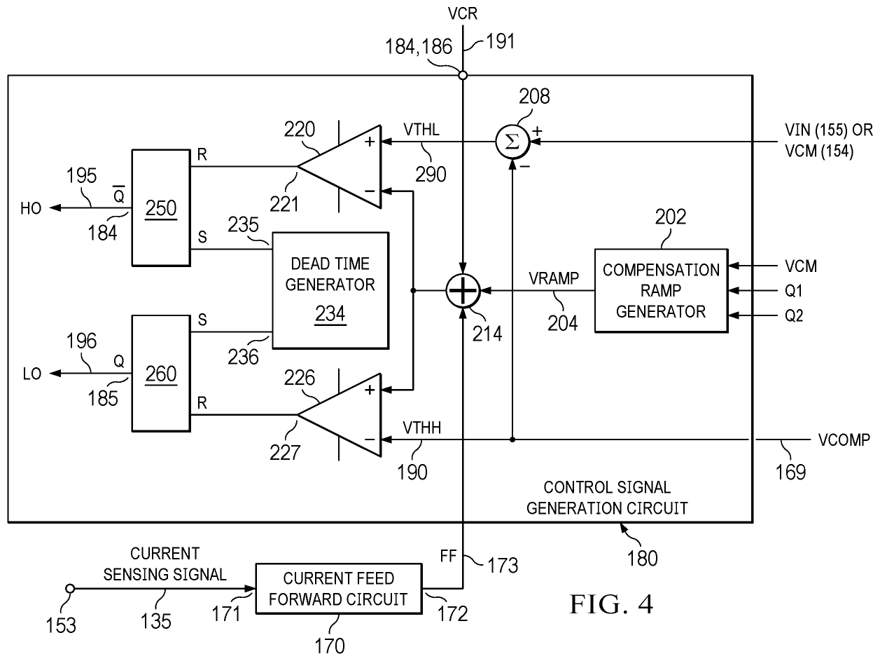

FIG. 4 is a schematic diagram showing another example control signal generation circuit 180 coupled to the current feedforward circuit. The schematic diagram is largely the same as that shown in FIG. 2. A difference, however, is that output 172 of current feedforward circuit 170 is coupled to an input of adder 214. Adder 214 adds the capacitor voltage VCR to the feedforward signal FF 193 from the current feedforward circuit 170 to produce a signal to the negative input of comparator 220 and positive input of comparator 226. Further, in the alternative example of FIG. 4, compensation signal VCOMP 169 is the threshold voltage VTTH 190.

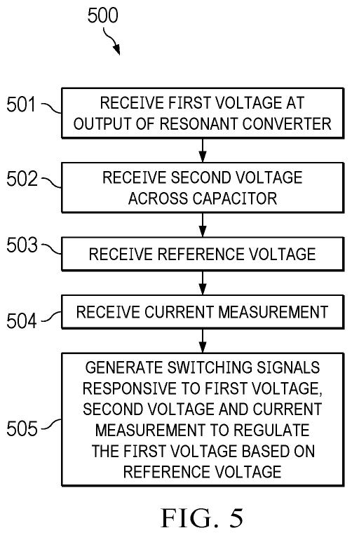

FIG. 5 is a flowchart 500 illustrating a method for the operation of a resonant converter in an example. The steps of flowchart 500 may be performed in the order shown or in a different order. In step 501, the method can include receiving a first voltage at the output of a resonant converter (e.g., power converter 100). For example, the first voltage can be VOUT. At step 502, the method can include receiving a second voltage across the resonant capacitor (e.g., VCR). At step 503, the method can include receiving a reference voltage (e.g., VREF). At step 504, the method can include receiving a current measurement (e.g., current sensing signal 135). Steps 501-504 can include receiving the respective voltages and current measurement into one or more analog-to-digital converters (ADCs) and then converting the respective analog signals into a digital format for further processing by the resonant controller 150. The aforementioned ADCs may be part of the resonant converter controller 150 or separate from the resonant converter controller 150. At step 505, the method can include generating switching signals (e.g., high and low command control signals HO and LO 195 and 196) responsive to the first voltage, the second voltage, and the current measurement to thereby regulate the first voltage (e.g., VOUT) based on the reference voltage. Examples of how the resonant converter controller 150 can generate the switching signals HO 195 are described above with reference to FIGS. 1-4. Specifically, the first voltage and the reference voltage can be processed using compensator 166 to generate VCOMP, while the current measurement is provided as a feedforward signal to bypass compensator 166, which allows faster response to the change in the load current and to reduce the voltage undershoot/overshoot due to the load current change.

FIG. 6 is a block diagram of an example processor platform 600 including processor circuitry structured to execute the example machine-readable instructions and/or the example operations of FIG. 5 to implement the power converter of FIGS. 1, 2, and 4. Processor platform 600 of the illustrated example can include processor circuitry 612. The processor circuitry 612 of the illustrated example includes hardware. For example, processor circuitry 812 can be implemented by one or more integrated circuits, logic circuits, FPGAs, microprocessors, central processing units (CPUs), graphical processing units (GPUs), digital signal processors (DSPs), and/or microcontrollers from any desired family or manufacturer. Processor circuitry 612 can be implemented by one or more semiconductor-based (e.g., silicon-based) devices. In this example, processor circuitry 612 can implement the resonant converter controller 150 of FIGS. 1, 2, and/or 4.

Processor circuitry 612 of the illustrated example can include a local memory 613 (e.g., a cache, registers, etc.). Processor circuitry 612 of the illustrated example is in communication with a computer-readable storage device such as a main memory including a volatile memory 614 and a non-volatile memory 616 by a bus 618. The volatile memory 614 can be implemented by, for example, Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 616 may be implemented by programmable read-only memory, flash memory and/or any other desired type of non-volatile memory device. Access to the main memory 614, 616 of the illustrated example can be controlled by a memory controller 617.

The processor platform 600 of the illustrated example also includes interface circuitry 620. The interface circuitry 620 may be implemented by hardware in accordance with any type of interface standard, such as an Inter-Integrated Circuit (I2C) interface, a Serial Peripheral Interface (SPI), an Ethernet interface, a universal serial bus (USB) interface, a Bluetooth® interface, a near field communication (NFC) interface, a Peripheral Component Interconnect (PCI) interface, and/or a Peripheral Component Interconnect Express (PCIe) interface.

In the illustrated example, one or more input ADCs 622 are connected to bus 618. The ADCs 622 can convert analog signals to digital signals for processing by the processor circuitry 612. Examples of such analog signals include the current sensing signal 135, input voltage VIN, common mode voltage VCM, the output voltage VOUT, and the reference voltage VREF.

One or more output devices 624 can be connected to the interface circuitry 620 of the illustrated example. The output device(s) 824 can include circuits such as driver circuits for generating, for example, the high command control signal HO and the low command control signal LO.

Machine-readable instructions 632 can be stored in volatile memory 814 and/or non-volatile memory 616. Upon execution by the processor circuitry 612, the machine-readable instructions 632 cause the processor platform 600 to perform any or all of the functionality described herein attributed to the resonant converter controller 150 including the steps of FIG. 5.

In this description, the term “couple” may cover connections, communications, or signal paths that enable a functional relationship consistent with this description. For example, if device A generates a signal to control device B to perform an action: (a) in a first example, device A is coupled to device B by direct connection; or (b) in a second example, device A is coupled to device B through intervening component C if intervening component C does not alter the functional relationship between device A and device B, such that device B is controlled by device A via the control signal generated by device A.

Also, in this description, the recitation “based on” means “based at least in part on.” Therefore, if X is based on Y, then X may be a function of Y and any number of other factors.

A device that is “configured to” perform a task or function may be configured (e.g., programmed and/or hardwired) at a time of manufacturing by a manufacturer to perform the function and/or may be configurable (or reconfigurable) by a user after manufacturing to perform the function and/or other additional or alternative functions. The configuring may be through firmware and/or software programming of the device, through a construction and/or layout of hardware components and interconnections of the device, or a combination thereof.

As used herein, the terms “terminal”, “node”, “interconnection”, “pin” and “lead” are used interchangeably. Unless specifically stated to the contrary, these terms are generally used to mean an interconnection between or a terminus of a device element, a circuit element, an integrated circuit, a device or other electronics or semiconductor component.

A circuit or device that is described herein as including certain components may instead be adapted to be coupled to those components to form the described circuitry or device. For example, a structure described as including one or more semiconductor elements (such as transistors), one or more passive elements (such as resistors, capacitors, and/or inductors), and/or one or more sources (such as voltage and/or current sources) may instead include only the semiconductor elements within a single physical device (e.g., a semiconductor die and/or integrated circuit (IC) package) and may be adapted to be coupled to at least some of the passive elements and/or the sources to form the described structure either at a time of manufacture or after a time of manufacture, for example, by an end-user and/or a third-party.

While the use of particular transistors is described herein, other transistors (or equivalent devices) may be used instead with little or no change to the remaining circuitry. For example, a field effect transistor (“FET”) (such as an n-channel FET (NFET) or a p-channel FET (PFET)), a bipolar junction transistor (BJT—e.g., NPN transistor or PNP transistor), an insulated gate bipolar transistor (IGBT), and/or a junction field effect transistor (JFET) may be used in place of or in conjunction with the devices described herein. The transistors may be depletion mode devices, drain-extended devices, enhancement mode devices, natural transistors or other types of device structure transistors. Furthermore, the devices may be implemented in/over a silicon substrate (Si), a silicon carbide substrate (SiC), a gallium nitride substrate (GaN) or a gallium arsenide substrate (GaAs).

References may be made in the claims to a transistor's control input and its current terminals. In the context of a FET, the control input is the gate, and the current terminals are the drain and source. In the context of a BJT, the control input is the base, and the current terminals are the collector and emitter.

References herein to a FET being “ON” or “enabled” means that the conduction channel of the FET is present and drain current may flow through the FET. References herein to a FET being “OFF” or “disabled” means that the conduction channel is not present so drain current does not flow through the FET. An “OFF” FET, however, may have current flowing through the transistor's body-diode.

Circuits described herein are reconfigurable to include additional or different components to provide functionality at least partially similar to functionality available prior to the component replacement. Components shown as resistors, unless otherwise stated, are generally representative of any one or more elements coupled in series and/or parallel to provide an amount of impedance represented by the resistor shown. For example, a resistor or capacitor shown and described herein as a single component may instead be multiple resistors or capacitors, respectively, coupled in parallel between the same nodes. For example, a resistor or capacitor shown and described herein as a single component may instead be multiple resistors or capacitors, respectively, coupled in series between the same two nodes as the single resistor or capacitor.

While certain elements of the described examples may be included in an integrated circuit and other elements may be external to the integrated circuit, in other example embodiments, additional or fewer features may be incorporated into the integrated circuit. In addition, some or all of the features illustrated as being external to the integrated circuit may be included in the integrated circuit and/or some features illustrated as being internal to the integrated circuit may be incorporated outside of the integrated. As used herein, the term “integrated circuit” means one or more circuits that are: (i) incorporated in/over a semiconductor substrate; (ii) incorporated in a single semiconductor package; (iii) incorporated into the same module; and/or (iv) incorporated in/on the same printed circuit board.

In this description, unless otherwise stated, “about,” “approximately” or “substantially” preceding a parameter means being within +/−10 percent of that parameter or, if the parameter is zero, a reasonable range of values around zero.

Modifications are possible in the described embodiments, and other embodiments are possible, within the scope of the claims.

What is claimed is:

1. An apparatus comprising:
a resonant converter controller having a converter voltage sensing terminal, a reference voltage terminal, a converter current sensing terminal, first and second converter capacitor terminals, and first and second control outputs, the resonant converter controller configured to:
receive a current sensing signal at the converter current sensing terminal;
generate a first signal based on the current sensing signal;
generate a second signal representing a difference between a first voltage at the converter voltage sensing terminal and a reference voltage at the reference voltage terminal; and
generate first and second switching signals at, respectively, the first and second control outputs responsive to the first signal, the second signal, and a capacitor voltage between the first and second converter capacitor terminals to regulate the first voltage based on the reference voltage.

2. The apparatus of claim 1, wherein the resonant converter controller includes:
a current feedforward circuit having a feedforward input and a feedforward output, the feedforward input coupled to the converter current sensing terminal, and the current feedforward circuit configured to generate the first signal at the feedforward output;
a compensator having a first compensator input, a second compensator input, and a compensator output, the first compensator input coupled to the converter voltage sensing terminal, the second compensator input coupled to the reference voltage terminal, the compensator configured to generate the second signal at the compensator output;
a summation circuit having a first summation input, a second summation input, and a summation output, the first summation input coupled to the feedforward output, and the second summation input coupled to the compensator output; and
a control signal generation circuit having a first control input, a second control input, and the first and second control outputs, the first control input coupled to the first and second converter capacitor terminals, and the second control input coupled to the summation output.

3. The apparatus of claim 2, wherein the current feedforward circuit is configured to adjust the first signal responsive to a change in the current sensing signal after a first delay;
wherein the compensator is configured to adjust the second signal responsive to a change in the first voltage after a second delay; and
wherein the second delay is longer than the first delay.

4. The apparatus of claim 2, wherein the current feedforward circuit is configured to generate the first signal based on at least one of: a converter output voltage, a converter input voltage, a resonant capacitance, or a switching frequency.

5. The apparatus of claim 4, wherein the converter output voltage is based on the first voltage.

6. The apparatus of claim 2, wherein the current feedforward circuit is configured to generate the first signal as a linear function of the current sensing signal.

7. The apparatus of claim 2, wherein the converter voltage sensing terminal is a first converter voltage sensing terminal, the resonant converter controller has a second converter voltage sensing terminal, the control signal generation circuit has a third input coupled to the second converter voltage sensing terminal, and the control signal generation circuit is configured to generate the first and second switching signals responsive to a second voltage at the third input.

8. The apparatus of claim 7, wherein the control signal generation circuit is configured to:
generate a first threshold based on a summation signal at the second control input;
generate a second threshold based on the second voltage and the summation signal;
generate a third signal based on the capacitor voltage; and
set the first and second switching signals responsive to a comparison between the third signal and the first and second thresholds.

9. The apparatus of claim 8, wherein the control signal generation circuit is configured to:
transition the first switching signal from a first state to a second state, and set the second switching signal in a third state;
when the first switching signal is in the second state, generate the third signal based on the capacitor voltage and a first ramp that increases with time;
responsive to the third signal exceeding the first threshold, transition the first switching signal from the second state to the first state;
transition the second switching signal from the third state to a fourth state, and set the first switching signal in the first state;
when the second switching signal is in the fourth state, generate the third signal based on the capacitor voltage and a second ramp that decreases with time; and
responsive to the third signal falling below the second threshold, transition the second switching signal from the fourth state to the third state.

10. The apparatus of claim 9, wherein the control signal generation circuit includes a dead time control circuit configured to trigger the transitioning of the first switching signal from the first state to the second state, and to trigger the transitioning of the second switching signal from the third state to the fourth state.

11. The apparatus of claim 9, further comprising a first transistor and a second transistor coupled between first and second converter power inputs, the first transistor having a first control terminal coupled to the first control output, and the second transistor having a second control terminal coupled to the second control output;
wherein the first transistor is enabled responsive to the first switching signal having the second state, and is disabled responsive to the first switching signal having the first state; and
wherein the second transistor is enabled responsive to the second switching signal having the fourth state, and is disabled responsive to the second switching signal having the third state.

12. The apparatus of claim 11, wherein the first transistor is coupled to the second transistor at a switching terminal, and the apparatus further comprises a first inductor, a second inductor, and a capacitor coupled in series between the switching terminal and the second converter power input, the capacitor having first and second capacitor terminals, the first capacitor terminal coupled to the first converter capacitor terminal, and the second capacitor terminal coupled to the second converter capacitor terminal.

13. A power converter, comprising:
a first transistor coupled between a first converter power input and a switching terminal, the first transistor having a first control input;
a second transistor coupled between the switching terminal and a second converter power input, the second transistor having a second control terminal;
a transformer having a primary winding and having a secondary winding;
an inductor coupled between the switching terminal and the primary winding;
a capacitor coupled between the primary winding and the second converter input, the capacitor having first and second capacitor terminals; a rectifier circuit coupled to the secondary winding, the rectifier circuit having a power converter output; and
a resonant converter controller having a converter voltage sensing terminal coupled to the power converter output, a reference voltage terminal, a converter current sensing terminal, first and second converter capacitor terminals coupled to respective first and second capacitor terminals, and first and second control outputs coupled to respective first and second control terminals, the resonant converter controller configured to:
receive a current sensing signal at the converter current sensing terminal;
generate a first signal based on the current sensing signal;
generate a second signal representing a difference between a first voltage at the converter voltage sensing terminal and a reference voltage at the reference voltage terminal; and
generate first and second switching signals at, respectively, the first and second control outputs responsive to the first signal, the second signal, and a capacitor voltage between the first and second converter capacitor terminals to regulate the first voltage based on the reference voltage.

14. The power converter of claim 13, wherein the resonant converter controller includes:
a current feedforward circuit having a feedforward input and a feedforward output, the feedforward input coupled to the converter current sensing terminal, and the current feedforward circuit configured to generate the first signal at the feedforward output;
a compensator having a first input, a second input, and a compensator output, the first input coupled to the converter voltage sensing terminal, the second input coupled to the reference voltage terminal, the compensator configured to generate the second signal at the compensator output;
a summation circuit having a first summation input, a second summation input, and a summation output, the first summation input coupled to the feedforward output, and the second summation input coupled to the compensator output; and
a control signal generation circuit having a first control input, a second control input, and the first and second control outputs, the first control input coupled to the first and second converter capacitor terminals, and the second control input coupled to the summation output.

15. The power converter of claim 14, wherein the current feedforward circuit is configured to generate the first signal based on at least one of: a converter output voltage, a converter input voltage, a resonant capacitance, or a switching frequency.

16. The power converter of claim 15, wherein the converter output voltage is based on the first voltage.

17. The power converter of claim 14, wherein the current feedforward circuit is configured to generate the first signal as a linear function of the current sensing signal.

18. A method comprising:
receiving a first voltage from an output of a resonant converter;
receiving a second voltage across a capacitor of the resonant converter;
receiving a reference voltage;
receiving a current measurement signal from the output of the resonant converter; and
generating a switching signal of the resonant converter responsive to the first voltage, the second voltage, and the current measurement signal to regulate the first voltage based on the reference voltage.

19. The method of claim 18, further comprising:
generating a first signal based on the current measurement signal;
generating a second signal representing a difference between the first voltage and the reference voltage; and
generating the switching signal based on the first and second signals.

20. A non-transitory computer readable medium storing instructions that, when executed by processor circuitry, cause the processor circuitry to:
receive a first voltage from an output of a resonant converter;
receive a second voltage across a capacitor of the resonant converter;
receive a reference voltage;
receive a current measurement signal from the output of the resonant converter; and
generate a switching signal of the resonant converter responsive to the first voltage, the second voltage, and the current measurement signal to regulate the first voltage based on the reference voltage.

21. The non-transitory computer readable medium of claim 20, wherein the instructions, when executed, cause the processor circuitry to:
generate a first signal based on the current measurement signal;
generate a second signal representing a difference between the first voltage and the reference voltage; and
generate the switching signal based on the first and second signals.
